(19) United States
(12) Patent Application Publication
(10) Pub. No.: US 2019/0333099 A1
(43) Pub. Date: Oct. 31, 2019

(54) METHOD AND SYSTEM FOR IP ADDRESS TRAFFIC BASED DETECTION OF FRAUD

(71) Applicant: Affle (India) Limited, Mumbai City (IN)

(72) Inventors: Anuj Khanna SOHUM, Singapore (SG); Charles Yong Jien FOONG, Singapore (SG); Anurag SINGH, Gurgaon (IN)

(73) Assignee: Affle (India) Limited, Mumbai City (IN)

(21) Appl. No.: 16/399,637

(22) Filed: Apr. 30, 2019

(30) Foreign Application Priority Data
Apr. 30, 2018 (IN) 201821016230

(51) Int. Cl. G06Q 30/02; H04L 29/06

(52) U.S. Cl. CPC G06Q 30/0248; H04L 63/0236; H04L 63/1425; G06Q 30/0246

(57) ABSTRACT

The present disclosure provides a method and system to detect advertisement fraud. The system receives the IP address data which is being used for viewing one or more advertisements published on at least one publisher on one or more media devices. In addition, the system classifies the IP address data into a plurality of classes. Further, the system analyzes abnormal traffic based on a plurality of parameters and the IP address data. Moreover, the system allocates the IP address into a blacklist when score exceeds threshold limit.

### TECHNICAL FIELD

The present disclosure relates to the field of fraud detection systems and, in particular, relates to a method and system to detect advertisement fraud based on IP address.

### INTRODUCTION

With the advancements in technology over the last few years, users have predominantly shifted towards smartphones for accessing multimedia content. Nowadays, users access content through a number of mobile applications available for download through various online application stores. Businesses (Advertisers) have started focusing on generating revenue by targeting consumers through these mobile applications. In addition, businesses have started investing heavily on doing business through these mobile applications. Moreover, businesses (publishers and/or advertising networks) have started developing advertisement capable applications for serving advertisements through these mobile applications. These advertisements are published in real time or fixed placements through these mobile applications and watched by the users. The advertisers are benefited in terms of internet traffic generated on clicking, taking action like installing or on watching these advertisements. However, certain online publishers and advertising networks working with these publishers take undue advantage of this in order to generate high revenues. These online publishers and advertising networks employ fraudulent techniques in order to generate clicks, or increasing actions like increasing number of application installs for the advertisers through fraudulent means. In addition, these online publishers' uses different IP addresses of the network devices for clicking in links, downloading applications and the like. This results in a loss of advertisers marketing budget spent as many times these publishers claim a normal user-initiated action (Organic action, e.g. Organic Install) as one initiated by them or at times the clicks or application installs are not driven by humans at all and instead by bots. There is a consistent need to stop publishers from performing such types of click fraud and transaction fraud.

### SUMMARY

In one aspect, the present disclosure provides a computer system. The computer system includes one or more processors and a memory. The memory is coupled to the one or more processors. The memory stores instructions. The instructions are executed by the one or more processors. The execution of instructions causes the one or more processors to perform a method to detect advertisement fraud. The method includes a first step to receive a first step of receiving IP address data being used for viewing one or more advertisements published on at least one publisher on one or more media devices. In addition, the method includes second step to classify the IP address data into a plurality of classes. Further, the method includes third step to segregate the IP address data based on traffic at the IP address. Furthermore, the method includes fourth step to analyze abnormal traffic based on a plurality of parameters and the IP address data. Furthermore, the method includes fifth step to score each of the IP address from the IP address data based on the analysis of the abnormal traffic. Moreover, the method includes a sixth step to allocate the IP address into blacklist where score exceeds threshold limit. The classification is done based on a plurality of third party databases and device data of the one or more media devices collected from a plurality of sources. The segregation is done to identify the traffic at the IP address being normal traffic or abnormal traffic. The segregation is done in real time. The analysis is done after segregating the IP address based on traffic at IP address. The analysis is done when a signal generator circuitry embedded inside the one or more media devices generates a signal to trigger one or more hardware components of the one or more media devices. The allocation is done in real time.

### BRIEF DESCRIPTION OF DRAWINGS

Having thus described the invention in general terms, references will now be made to the accompanying figures, wherein:

FIG. 1A illustrates an interactive computing environment for detection of advertisement fraud in real time, in accordance with various embodiments of the present disclosure;

FIG. 1B illustrates block diagram of various modules of the interactive computing environment, in accordance with various embodiments of the present disclosure;

FIG. 2 illustrates a flow chart of a method for detection of advertisement fraud in real time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

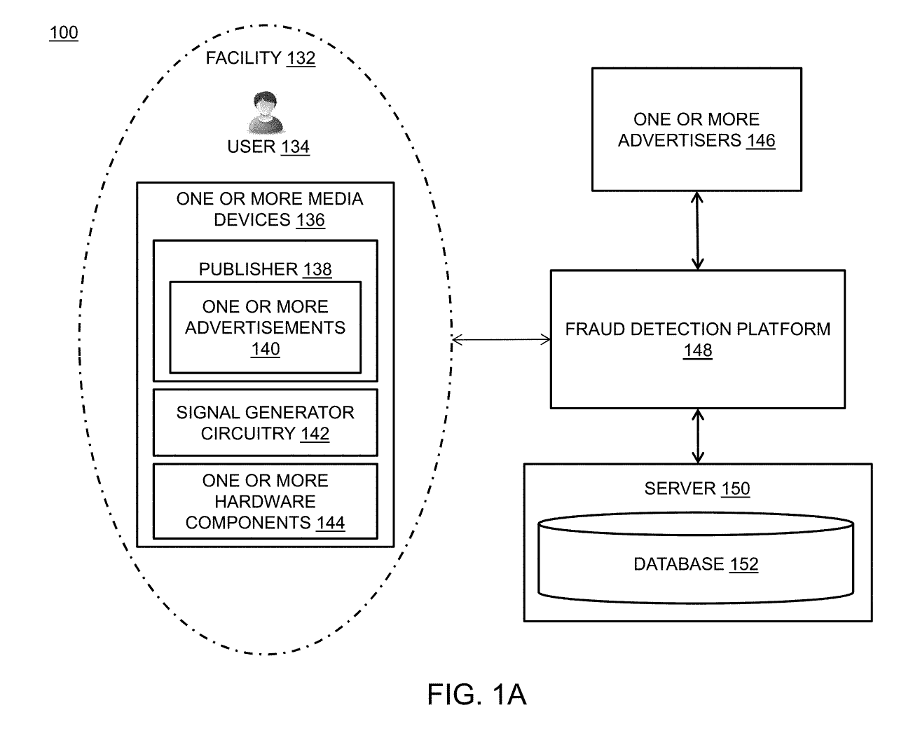

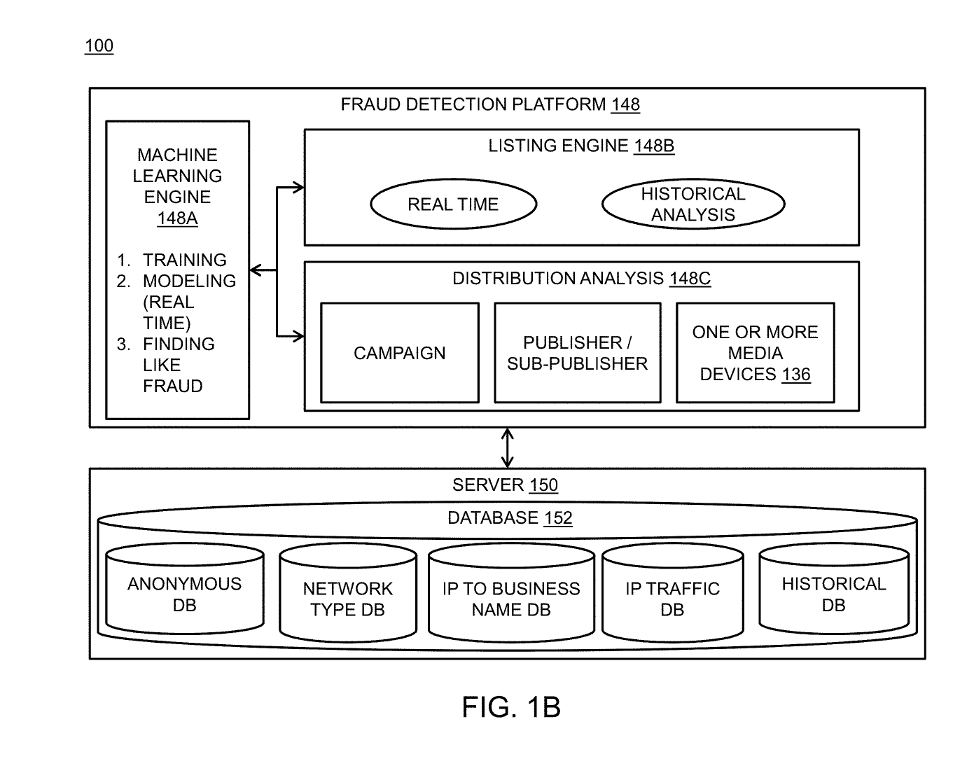

FIG. 1A illustrates an interactive computing environment 100 for detection of an advertisement fraud in real time. The interactive computing environment 100 shows a relationship between various entities involved in detection of fraud in an advertisement based on IP address. The advertisement fraud is a type of fraud which is being done to generate more revenue from the advertisement being displayed by generating fake online traffic. The fake online traffic is faked through techniques such as click fraud, transaction fraud and the like. The click fraud corresponds to regular or constant clicking by a user 134 or group of users on the advertisement in order to generate more revenue for a publisher 138. The click fraud is when the publisher 138 gets paid based on pay-per-click or pay-per-view bases whenever the advertisement gets clicked. The click fraud refers to the generation of fraudulent clicks through online bots which are not identifiable and are treated as genuine online traffic. The transaction fraud refers to initiating install via fake clicks and bots (as described above in the application). The transaction fraud takes place when the publisher 138 applies fraudulent techniques to drive fake installs of applications in order to generate more revenue.

The interactive computing environment 100 includes a facility 132, the user 134, one or more media devices 136, the publisher 138, one or more advertisements 140, a signal generator circuitry 142, one or more hardware components 144, one or more advertisers 146, a fraud detection platform 148, a server 150 and a database 152. Each of the components of the interactive computing environment 100 interacts with each other to enable detection of advertisement fraud in real time based on traffic at the IP address.

The interactive computing environment includes the facility 132 which is a place where the user 134 is present at the time of using the network hardware in the IP based network. The facility 132 includes home, shopping malls, hotels, internet café, company, education institution, bus stand, railway station, metro station, and the like. The facility 132 includes but may not be limited to co-working place, subway, park, historical places and conference hall. The facility 132 is any place where the IP based network for the hardware can be established. The facility 132 is any place where the user 134 is having access to the IP based network for his use.

The user 134 is any person who is present in the facility 132 having the IP based network for accessing the multimedia content. The user 132 may be any legal person or natural person who access online multimedia content and need an IP based network for accessing the multimedia content. In addition, the user 134 is an individual or person who access online multimedia content on the respective one or more media devices 136. Further, the user may be a computer or bots who is programmed to view the advertisement and performs click and transaction in order to fraud. In an embodiment of the present disclosure, the user 134 includes but may not be limited to a natural person, legal entity, individual, machine, robots and the like for viewing advertisement. The user 134 is associated with the one or more media devices 136.

The interactive computing environment further includes the one or more media devices 136 which help to communicate information. The one or more media devices 136 includes but may not be limited to a Smartphone, a laptop, a desktop computer, a tablet and a personal digital assistant. In an embodiment of the present disclosure, the one or more media devices include a smart television, a workstation, an electronic wearable device and the like. In an embodiment, the one or more media devices 136 include portable communication devices and fixed communication devices. In an embodiment of the present disclosure, the one or more media devices 136 are currently in the switched-on state. The user 132 accesses the one or more media devices 136 in real time. The one or more media devices 136 are any type of devices having an active internet facility. The one or more media devices 136 are internet-enabled device for allowing the user 134 to access the publisher 138. In an embodiment of the present disclosure, the user 132 may be an owner of the one or more media devices 136. In another embodiment of the present disclosure, the user 132 may not be the owner of the one or more media devices 136. In addition, the one or more media devices 136 are used for viewing an application which is installed on the one or more media devices 136.

The interactive computing environment 100 further includes the publisher 138 which is used for viewing content on the one or more media devices 136. The publisher 138 includes but may not be limited to mobile application, web application and website. The publisher 138 is the mobile application which displays content to the user 134 on the one or more media devices 136. The content may include one or more publisher content, one or more video content and the like. The application or the publisher 138 accessed by the user 134 shows content related to interest of the users 134. In an example, the user 134 may be interested in watching online videos, reading blogs, play online games, accessing social networking sites and the like. The publisher 138 is the application developed by the application developer for viewing or accessing specific content. The publisher 138 or applications are advertisement supporting applications which are stored on the one or more media devices 136. The publishers 138 or mobile applications are of many type which includes gaming application, a utility application, a service based application and the like. The publishers 138 provide space, frame, area or a part of their application pages for advertising purposes which is referred to as advertisement slots. The publisher 138 consists of various advertisement slots which depend on the choice of the publisher 138. The publishers 138 advertise products, services or businesses to the users 134 for generating revenue. The publisher 138 displays the one or more advertisements 140 on the one or more devices 136 when the user 134 is accessing the publisher 138.

The one or more advertisement 140 is a graphical or pictorial representation of the information in order to promote a product, an event, service and the like. In general, the one or more advertisements 140 are a medium for promoting a product, service, or an event. The one or more advertisements 140 include text advertisement, video advertisement, graphic advertisement and the like. The one or more advertisements 140 are displayed in third party applications developed by application developers. The one or more advertisements 140 are presented to attract the user 134 based on his interest in order to generate revenue. The one or more advertisements 140 are presented to the user 134 on the publisher 138 based on interest of the user 134 which is shown for a specific period of time. The user 134 click on the one or more advertisement 140 and the user 134 is re-directed to a website or application or application store associated with the clicked one or more advertisements 140. The one or more advertisements 140 are provided to the publisher 138 by the one or more advertisers 146 who want to advertise their product, service through the publisher 138. The publisher 138 gets paid if the user 134 visits the application or website through the one or more advertisements 140 of the one or more advertisers 146. The number of user 134 who visits the one or more advertisements 140 through the publisher 138 generates more revenue for the publisher 138.

The one or more advertisers 146 are those who want to advertise their product or service and the like to the user 134. The one or more advertisers 146 approach the publisher 138 and provide the one or more advertisements 140 to be displayed for the user 134 on the publisher 138. The one or more advertisers 146 pay the publisher 138 based on the number of user 134 being redirected or taking the product or services provided by the one or more advertisers 146.

The one or more advertisements 140 are placed on the advertisement slots in the publisher application on the one or more media devices 136 associated with the user 134. The one or more advertisers 146 purchase the advertisement slots from the publisher 138. The one or more advertisements 140 may be served based on a real-time bidding technique or a direct contract between the one or more advertisers 146 and the publisher 138. The one or more advertisers 146 may provide the one or more advertisements 140 to advertising networks and information associated with advertising campaigns. The advertisement networks enable display of the one or more advertisements 140 in real time on the publisher 138 on behalf of the one or more advertisers 146. The advertising networks are entities that connect the one or more advertisers 146 to websites and mobile applications that are willing to serve advertisements.

The interactive computing environment 100 further includes the signal generator circuitry 142 for generating signal and to trigger the one or hardware component 144 associated with the one or more media devices 136. The one or more hardware components 144 are triggered for one or more purposes. The one or more purposes includes but may not be limited to receiving data, connection establishment between a plurality of third party databases and fraud detection platform 148. The one or more purposes include but may not be limited to blocking the IP address, sending and receiving information, and the like. The one or more purposes include generating a signal based on the requirement of the fraud detection platform 148. The signal generator circuitry 142 triggers the one or more hardware components 144 to perform a specific task in the one or more media devices 136.

The one or more hardware components 144 are components which are embedded inside the one or more media devices 136. The one or more hardware components 144 include but may not be limited to camera, microphone, LED, light sensor, proximity sensor and accelerometer sensor. The one or more hardware components 144 include but may not be limited to gyroscope, compass and the like. The one or more hardware components 144 are triggered when the signal generator circuitry embedded inside the one or more media devices 136 generates a signal to trigger the one or more hardware components 144.

The interactive computing environment 100 further includes the fraud detection platform 148 which is associated with the publisher 138 and the one or more advertisers 146. The fraud detection platform 148 detects advertisement fraud being done by the publisher 138 in order to generated fake traffic for the one or more advertisements 140. The fraud detection platform 148 is linked with the publisher 138 which may be more than one in real time. The fraud detection platform 148 is a platform for detecting click fraud and transaction fraud done by the publisher 138. The fraud detection platform 148 performs the detection of fraud in the one or more advertisements 140 in real time. The fraud detection platform 148 performs the detection of fraud by performing sequence of tasks which includes but may not be limited to receiving IP addresses, clustering IP addresses and analyzing IP address. Further, the fraud detection platform 148 performs the tasks of integrating with the plurality of third party databases, segregating, maintaining IP addresses, blocking the fraud IP address and the like.

Reference will now be made to the components mentioned in FIG. 1B in order to explain the embodiments of the fraud detection platform 148. FIG. 1A illustrates the various module of the interactive computing environment 100.

The fraud detection platform 148 receives the IP address data which is being used by the user 134 for viewing the one or more advertisements 140 on the publisher 138. In general, the IP address is a unique code assigned to a device connected to a computer network. The IP address is assigned to the device which is used for providing communication and uniquely identifies device from each other during the communication. The fraud detection platform 148 receives the IP address data which is further managed in order to identify fraud.

The fraud detection platform 148 initiates the signal generator circuitry 142 in order to generate a signal. The signal generated by the signal generator circuitry 142 activates a plurality of sources or the one or more hardware components embedded inside the one or more media devices which are used for collecting device data. In an embodiment of the present disclosure, the plurality of sources may not be embedded inside the one or more media devices 136. In an embodiment of the present disclosure, the plurality of sources includes but may not be limited to accelerometer, ambient light sensor, and global positioning system. In an embodiment of the present disclosure, the plurality of sources includes proximity sensor, compass, pressure sensor, operating system and gyroscope.

In addition, the fraud detection platform 148 receives the device data from the plurality of sources which includes network type, service provider, location and the like. In an embodiment of the present disclosure, the device data includes but may not be limited to time-stamp, operating system, model number, device id and number of application installed. In another embodiment of the present disclosure, the device data includes GPS data, number of application uninstalled, screen size, device date, device time and the like.

Further, the fraud detection platform 148 generates a signal using the signal generator circuitry 142 in order to establish connection between the plurality of third party databases. The connection is established between the plurality of third party databases and the fraud detection platform 148 for integrating the data of the plurality of third party databases with the database 152. The fraud detection platform 148 integrates with the plurality of third party databases in order to collect past data and data of the one or more media devices 136. The plurality of third party databases includes data which has been collected during past visits of the user 134 on the third party publisher.

The database 152 is as shown in FIG. 1B is where all the information is stored for accessing. The database 152 includes data which is pre-stored in the database and data collected in real-time. The database 152 may be a cloud database or any other database based on the requirement for the fraud detection. The data is stored in the database 152 in various tables. The tables are matrix which stored different type of data. In an example, one table may store data related to the user 134 and in other table the one or more media devices 136 related data is stored.

In an embodiment of the present disclosure, the database 152 includes anonyms DB, network type DB, IP to business name DB, IP traffic DB and the like as shown in FIG. 1B. In another embodiment of the present disclosure, the database 152 includes but may not be limited to historical DB, blocked IP DB and safe IP DB. The anonyms DB hold data related to public IP addresses, internet cafe IP addresses, shopping malls IP addresses, Airports IP addresses, hotel IP addresses, hosting providers and the like. The network type DB hold data related to type of network, the type of network includes home network, public network, tor networks and the like. The IP to business name DB hold data related to business IP, office IP and the like. The IP traffic DB hold data related to IP addresses, the publisher 138, the user 134 and the like. The historical DB is the data which is pre-defined or is already stored in the database 152. The database 152 is included inside the server 150 as shown in FIG. 1B.

The server 150 as shown in FIG. 1B is used to perform task of accepting request and respond to the request of other functions. The server 150 may be a cloud server which is used for cloud computing to enhance the real time processing of the system and using virtual space for task performance. In an embodiment of the present disclosure, the server 150 may be any other server based on the requirement for the fraud detection.

Furthermore, the fraud detection platform 148 classifies the IP address data into a plurality of classes based on the type of network being used for visiting the one or more advertisements 140. The classification is done based on the data collected from the plurality of third party databases and the device data of the one or more media devices. The plurality of classes is based on the type of network being used by the user 134 for visiting the one or more advertisements 140. The plurality of classes include but may not be limited to home network, shopping mall network, university network, company's network, public network and private network. In an embodiment of the present disclosure, the plurality of classes includes office network, college network, hub network, café network and the like. The classification is performed by the listing engine 148b of the fraud detection engine 148 which is shown in FIG. 1B. The listing engine 148b performs historical analysis of the data collected from the plurality of third party databases. The listing engine 148b performs historical analysis in order to identify network, number of users at the given time and classify the IP address data into plurality of classes.

The listing engine 148b as shown in FIG. 1B is used for listing the IP address data, data collected from the plurality of third party databases and the device data. The listing engine 148b performs historical analysis and real time analysis on the data received from the fraud detection platform 148. The listing engine 148b scrutinize the collected data in order to identify the behavior of the user 134, IP address being used for visiting the one or more advertisements 140. In an embodiment of the present disclosure, the listing engine 148b performs the task of identifying the network of the user, network speed, and the like. In an embodiment of the present disclosure, the listing engine 148b performs listing of the IP address into white list, classifying the IP address and the like. In another embodiment of the present disclosure, the listing engine 148b performs listing of IP address into blacklist; identify device ids associated with IP address and the like. The blacklist is list of IP addresses that are present in the plurality of third party databases as fraud and has been blocked by other publisher 138 from accessing the application or the publisher 138. The whitelist is the list of IP addresses which has been found to be valid IP address for accessing the publisher 138. The whitelist contain the list of the IP address and the user 134 having no fraudulent behavior through the use of these IP address.

Moreover, the fraud detection platform 148 performs calculation of a plurality of parameters based on the IP address data, the device data, the data collected from the plurality of third party databases. The plurality of parameters include but may not be limited to click to install time, time to run, time to load, device load time, redirection time and download time. The plurality of parameters include click to install network time, click to run network time, download network time and mobile speed and the like.

Also, the fraud detection platform 148 segregates the IP address data based on traffic at the IP address. The segregation of the IP address data is done into normal traffic and abnormal traffic. The segregation of the IP address is done in order to identify the abnormal traffic on the IP address based on the data collected from the listing engine 148b, the IP address data, the data collected from the plurality of third party databases and plurality of parameters. The segregation of the IP address data is done in order to identify the abnormal behavior on the IP address. The traffic is the number of user using the IP address in a network for accessing the publisher 138 at an instance. In an example, if people are using the public network than the number of user who accesses the publisher 138 using the public network will generate traffic at the publisher 138. The traffic generated is of two types which include the normal traffic and the abnormal traffic. The traffic generated is considered normal traffic if there are limited number of users at the given IP address. The traffic generated is considered abnormal traffic if the number of users is higher at the given IP address or the number of download from a particular IP address is higher.

In an example, the number of users clicking the advertisement from a particular IP are higher indicates an abnormal traffic and if the number of users are moderate than the traffic is considered as normal traffic at the given IP address.

Also, the fraud detection platform 148 performs examination of user behavior in order to identify abnormal traffic. The examination is done based on the device data, the IP address data, the data from the plurality of third party databases and the plurality of parameters. The examination is done to identify the user behavior and detects the abnormal traffic based on the user behavior. In an embodiment of the present disclosure, the examination of the user behavior involve the process for identifying the number of user that may be present at a particular places based on the local time, server time, one or more media devices 136 time. In another embodiment of the present disclosure, the examination of user behavior involve identifying the user 134 usage pattern based on the collected data in order to identify when the user is generating more traffic based on the local time of the location of the user 134. The user behavior is examined to identify if the traffic generated is an abnormal traffic or normal traffic.

In an example, if number of download being done at 1 am is higher and according to the user behavior it shows that the user 134 is sleeping. Further, it may the possibility of the IP address being used for the fraudulent activity during night time according to the user behavior and the location of the user 134. The traffic which is being generated may be traffic generated by using bots or by using network connected device in order to generate fake click and fake install.

Also, the fraud detection platform 148 performs analyses of the abnormal traffic in order to identify if the fraud is being committed by the publisher 138. The analysis is done in real-time. The analysis is done when the signal generator circuitry embedded inside the one or more media devices 136 generates a signal to trigger the one or more hardware components 144 of the one or more media devices 136. In an embodiment of the present disclosure, the signal generator circuitry embedded inside the one or more media devices 136 trigger the GPS to identify location of the one or more media devices 136 at an instance. The analysis is done by a machine learning engine 148a and distribution analysis 148c of the fraud detection platform 148.

The machine learning engine 148a as shown in FIG. 1B received IP address data, the data from the plurality of third party databases and the data collected from the segregated IP address. Further, the machine learning engine 148a receives real-time data of the one or more media devices 136. The machine learning engine 148a performs training on the data in order to identify pattern from the past data and the real-time data. The machine learning engine 148a also performs modeling of the data in real-time and the finding of like fraud based on the modeling and training of the data in order to identify. The like fraud corresponds to those frauds which show similar user behavior as it was there in the past data which shows that a fraudulent activity is being done. The machine learning engine 148a performs real time analysis based on the collected data from the database 152 and real-time data received from the user 134.

The distribution analysis 148c as shown in FIG. 1B perform analysis of the data based on the publisher 138, device and the campaign being run by the publisher 138. The distribution analysis 148c collects data stored in the database 152 and the data related to the publisher 138, the device data and the campaign being run by the one or more advertisers 146. The distribution analysis 148c performs the analysis of the real-time and past data in order to identify the fraud being committed by the publisher 138 by analyzing the data received from the publisher, the plurality of third party databases and the campaign data.

Also, the fraud detection platform 148 calculates a threshold limit based on the IP address data, the device data and the plurality of parameters. The threshold limit is the limit which identify if the abnormal traffic being generated is generated by any fraudulent using bots or software for generating more click fraud and transaction fraud. In an embodiment of the present disclosure, the fraud detection platform 148 calculates the threshold limit based on the location, the time-stamp, number of usage per IP, time distribution, number of device ID's per IP. In an embodiment of the present disclosure, the threshold limit may be entered by the one or more advertisers 146 in order to detect fraud.

Also, the fraud detection platform 148 calculates score for each the IP address from the IP address data based on the analysis of the abnormal traffic. The score of the IP address data is used to identify if the traffic at the IP address is fraud or genuine.

Also, the fraud detection platform 148 allocates the IP address into the blacklist if the score of the given IP address exceeds the threshold limit. Furthermore, if the score of the given IP address does not exceed the threshold limit than allocate the IP address into the whitelist.

In an embodiment of the present disclosure, the fraud detection platform 148 correlates the IP address data with geo-IP database in order to checks fraud being committed by the user 134. In general, the geo-IP database is a database which includes the IP address and the geo location of the user 134 at that instance when accessing using the IP address. In an embodiment of the present disclosure, the IP address data is distributed to the third party for integration and for sharing the fraud IP address data.

In an embodiment of the present disclosure, the fraud detection platform 148 updates the blacklist, whitelist, the IP address data, the plurality of third party databases, the traffic and the threshold limit. The fraud detection platform 148 performs updating in real time.

In an embodiment of the present disclosure, the fraud detection platform 148 stores the blacklist, whitelist, the IP address data, the plurality of third party databases, the traffic and the threshold limit. The fraud detection platform 148 performs storing in real time.

In an embodiment of the present disclosure, the fraud detection platform 148 send a mail or text to the publisher 138 and the one or more advertisers 146 about the user 134 performing fraud. In an embodiment of the present disclosure, the fraud detection platform 148 blocks the user 132 or the publishers 138 based on the IP address present in the blacklist in order to prevent further fraud.

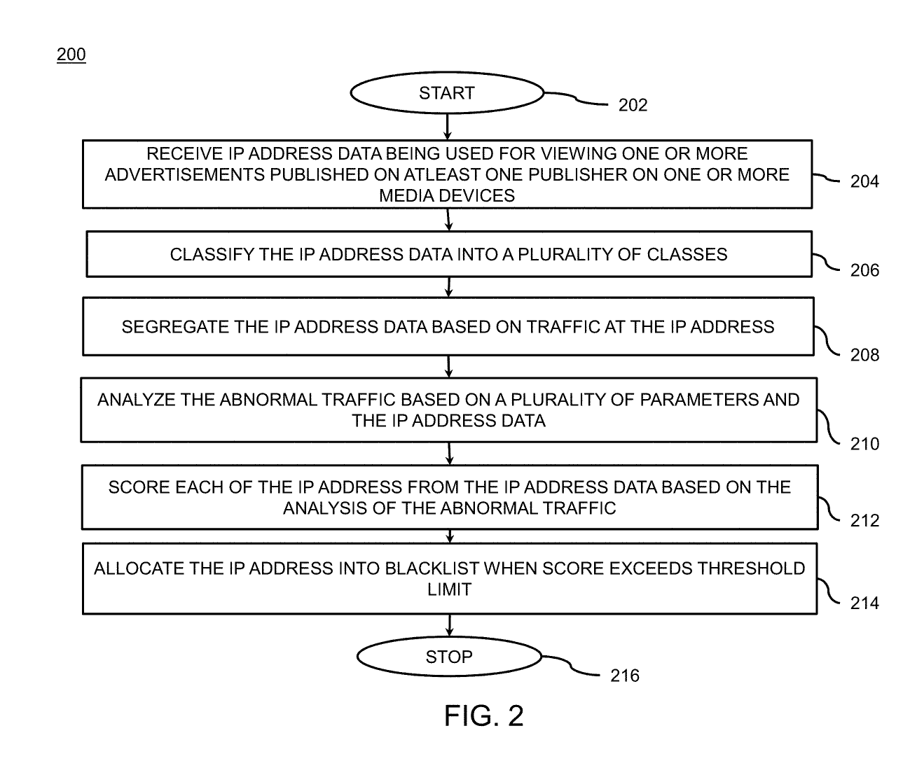

FIG. 2 illustrates a flow chart 200 for detecting advertisement fraud based on the IP address, in accordance with various embodiments of the present disclosure. It may be noted that to explain the process steps of flowchart 200, references will be made to the system elements of FIG. 1A and FIG. 1B. It may also be noted that the flowchart 200 may have fewer or more number of steps.

The flowchart 200 initiates at step 202. Following step 202, at step 204, the fraud detection platform 148 receives the IP address data being used for viewing the one or more advertisements 140 published on at least one publisher 138. The one or more advertisements are published on the one or more media devices 136. At step 206, the fraud detection platform 148 classifies the IP address data into the plurality of classes. At step 208, the fraud detection platform 148 segregates the IP address data based on traffic at the IP address. At step 210, fraud detection platform 148 analyzes the abnormal traffic based on a plurality of parameters and the IP address data. At step 212, fraud detection platform 148 scores each of the IP address from the IP address data based on the analysis of the abnormal traffic. At step 214, fraud detection platform 148 allocates the IP address into blacklist when score exceeds threshold limit. The flow chart 200 terminates at step 216.

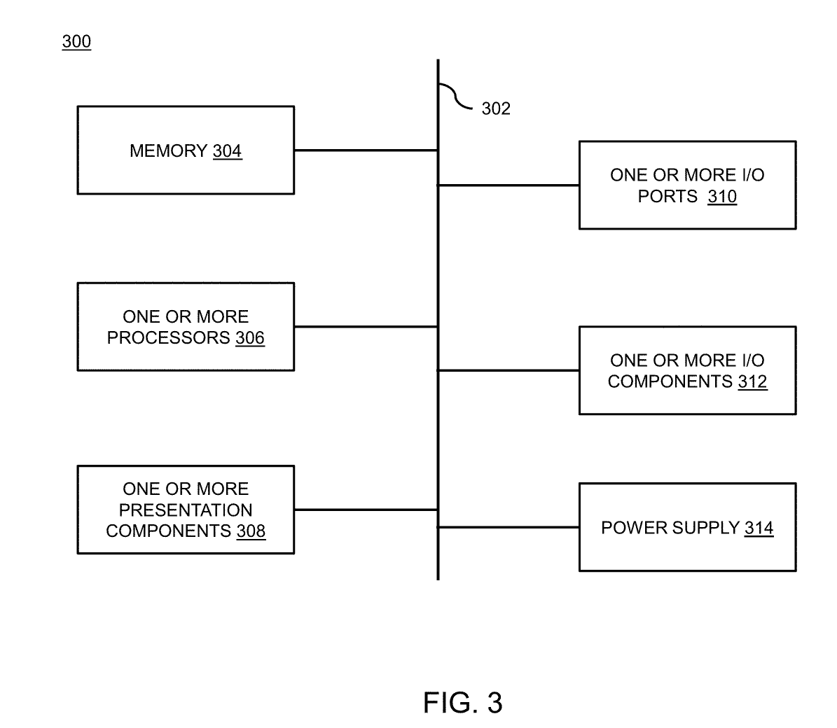

FIG. 3 illustrates a block diagram of a device 300, in accordance with various embodiments of the present disclosure. The device 300 is a non-transitory computer readable storage medium. The device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The device 300 includes the one or more processors 306 that read data from various entities such as memory 304 or I/O components 312. The one or more presentation components 308 present data indications to the user or other device. Exemplary presentation components include a display device, speaker, printing component, vibrating component, etc. The one or more I/O ports 310 allow the device 300 to be logically coupled to other devices including the one or more I/O components 312, some of which may be built in. Illustrative components include a microphone, joystick, gamepad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer system comprising:
one or more processors; and
a memory coupled to the one or more processors, the memory for storing instructions which, when executed by the one or more processors, cause the one or more processors to perform a method for detecting advertisement fraud based on IP address, the method comprising:
receiving, at a fraud detection platform, IP address data being used for viewing one or more advertisements published on at least one publisher on one or more media devices;
classifying, at the fraud detection platform, the IP address data into a plurality of classes, wherein the classification is done based on a plurality of third party databases and device data of the one or more media devices collected from a plurality of sources;
segregating, at the fraud detection platform, the IP address data based on traffic at the IP address, the segregation is done to identify the traffic at the IP address being normal traffic or abnormal traffic, wherein the segregation is done in real time;
analyzing, at the fraud detection platform, the abnormal traffic based on a plurality of parameters and the IP address data, wherein the analysis is done after segregating the IP address based on traffic at the IP address, wherein the analysis is done when a signal generator circuitry embedded inside the one or more media devices generates a signal to trigger one or more hardware components of the one or more media devices;
scoring, at the fraud detection platform, each of the IP address from the IP address data based on the analysis of the abnormal traffic; and
allocating, at the fraud detection platform, the IP address into blacklist when score exceeds threshold limit, wherein the allocation is done in real time.

2. The computer system as recited in claim 1, wherein the plurality of sources comprises accelerometer, ambient light sensor, global positioning system sensor, compass, proximity sensor, pressure sensor, operating system and gyroscope.

3. The computer system as recited in claim 1, wherein the device data comprises network type, service provider, location, time-stamp, operating system, model number, number of application installed, GPS data, number of application uninstalled and screen size.

4. The computer system as recited in claim 1, wherein the plurality of parameters comprises click to install time, time to run, time to load, device load time, redirection time and download time.

5. The computer system as recited in claim 1, wherein the plurality of third party databases comprises information regarding the one or more media devices, mobile network, the publisher, network speed, IP frequency, device ID's, publisher information, the blacklist, whitelist.

6. The computer system as recited in claim 1, wherein the plurality of classes is based on type of network being used for visiting the one or more advertisements, wherein the plurality of classes comprises home network, shopping mall network, university network, company's network, public network and private network.

7. The computer system as recited in claim 1, further comprising
examining, at the fraud detection platform, the user behavior to identify the abnormal traffic based on the device data, the IP address data, the data from the plurality of third party databases and the plurality of parameters, wherein the examination is done to identify the user behavior and detect the abnormal traffic based on the user behavior, wherein examination is done in real time.

8. The computer system as recited in claim 1, further comprising
calculating, at the fraud detection platform, the threshold limit based on the IP address data, the device data and the plurality of parameters.

9. A computer-implemented method for detecting advertisement fraud based on IP address, the computer-implemented method comprising:
receiving, at a fraud detection platform with a processor, IP address data being used for viewing one or more advertisements published on at least one publisher on one or more media devices;
classifying, at the fraud detection platform with the processor, the IP address data into a plurality of classes, wherein the classification is done based on a plurality of third party databases and device data of the one or more media devices collected from a plurality of sources;
segregating, at the fraud detection platform with the processor, the IP address data based on traffic at the IP address, the segregation is done to identify the traffic at the IP address being normal traffic or abnormal traffic, wherein the segregation is done in real time;
analyzing, at the fraud detection platform with the processor, the abnormal traffic based on a plurality of parameters and the IP address data, wherein the analysis is done after segregating the IP address based on traffic at the IP address, wherein the analysis is done when a signal generator circuitry embedded inside the one or more media devices generates a signal to trigger one or more hardware components of the one or more media devices;
scoring, at the fraud detection platform with the processor, each of the IP address from the IP address data based on the analysis of the abnormal traffic; and
allocating, at the fraud detection platform with the processor, the IP address into blacklist when score exceeds threshold limit, wherein the allocation is done in real time.

10. The computer-implemented method as recited in claim 9, wherein the plurality of sources comprises accelerometer, ambient light sensor, global positioning system sensor, compass, proximity sensor, pressure sensor, operating system and gyroscope.

11. The computer-implemented method as recited in claim 9, wherein the device data comprises network type, service provider, location, time-stamp, operating system, model number, number of application installed, GPS data, number of application uninstalled and screen size.

12. The computer-implemented method as recited in claim 9, wherein the plurality of parameters comprises click to install time, time to run, time to load, device load time, redirection time and download time.

13. The computer-implemented method as recited in claim 9, wherein the plurality of classes is based on type of network being used for visiting the one or more advertisements, wherein the plurality of classes comprises home network, shopping mall network, university network, company's network, public network and private network.

14. The computer-implemented method as recited in claim 9, wherein the plurality of third party databases comprises information regarding the one or more media devices, mobile network, the publisher, network speed, IP frequency, device ID's, publisher information, the blacklist, whitelist.

15. The computer-implemented method as recited in claim 9, further comprising
examining, at the fraud detection platform with the processor, the user behavior to identify the abnormal traffic based on the device data, the IP address data, the data from the plurality of third party databases and the plurality of parameters, wherein the examination is done to identify the user behavior and detect the abnormal traffic based on the user behavior, wherein examination is done in real time.

16. The computer-implemented method as recited in claim 9, further comprising
calculating, at the fraud detection platform with the processor, the threshold limit based on the IP address data, the device data and the plurality of parameters.

17. A non-transitory computer-readable storage medium encoding computer executable instructions that, when executed by at least one processor, performs a method for detecting advertisement fraud based on IP address, the method comprising:
receiving, at a computing device, IP address data being used for viewing one or more advertisements published on at least one publisher on one or more media devices;
classifying, at the computing device, the IP address data into a plurality of classes, wherein the classification is done based on a plurality of third party databases and device data of the one or more media devices collected from a plurality of sources;
segregating, at the computing device, the IP address data based on traffic at the IP address, the segregation is done to identify the traffic at the IP address being normal traffic or abnormal traffic, wherein the segregation is done in real time;
analyzing, at the computing device, the abnormal traffic based on a plurality of parameters and the IP address data, wherein the analysis is done after segregating the IP address based on traffic at the IP address, wherein the analysis is done when a signal generator circuitry embedded inside the one or more media devices generates a signal to trigger one or more hardware components of the one or more media devices;
scoring, at the computing device, each of the IP address from the IP address data based on the analysis of the abnormal traffic; and
allocating, at the computing device, the IP address into blacklist when score exceeds threshold limit, wherein the allocation is done in real time.
